(19) United States
(12) Patent Application Publication
(10) Pub. No.: US 2014/0222321 A1
(43) Pub. Date: Aug. 7, 2014

(54) TRAFFIC STATE ESTIMATION WITH INTEGRATION OF TRAFFIC, WEATHER, INCIDENT, PAVEMENT CONDITION, AND ROADWAY OPERATIONS DATA

(71) Applicant: ITERIS, INC., Santa Ana, CA (US)

(72) Inventors: KARL F. PETTY, BERKELEY, CA (US); ANDREW J. MOYLAN, BERKELEY, CA (US); JAIMYOUNG KWON, BERKELEY, CA (US); JOHN J. MEWES, MAYVILLE, ND (US)

(21) Appl. No.: 14/173,611

(22) Filed: Feb. 5, 2014

Related U.S. Application Data
(60) Provisional application No. 61/761,276, filed on Feb. 6, 2013.

(51) Int. Cl. G01C 21/34

(52) U.S. Cl. CPC G01C 21/3492
USPC 701/117; 701/533

(57) ABSTRACT

An integrated traffic state estimation framework ingests information from multiple input data sources having an impact on traffic flow and correlated to specific road links in a segmented roadway network, and generates output data representative of predictive traffic states. The predictive traffic states are then modeled to generate routing information for traffic on a particular section of roadway. These multiple input data sources include general traffic data collected from one or more sensors or third parties, weather data, incident data, pavement condition data, and roadway operations data, each of which includes data relevant to traffic congestion. The input data is weighted and modeled with data processing modules configured to integrate known and predicted information to produce accurate routing information for particular roadway segments for media, telematics, and consumer uses.

### CROSS-REFERENCE TO RELATED PATENT APPLICATIONS

This patent application claims priority to U.S. provisional application 61/761,276, filed on Feb. 6, 2013, the contents of which are incorporated in their entirety herein.

### FIELD OF THE INVENTION

The present invention relates to modeling and estimating traffic states. Specifically, the present invention relates to integrating traffic, weather, incident, pavement condition, and roadway operational data to model and estimate traffic states for generating routing information for consumer and commercial utility.

### BACKGROUND OF THE INVENTION

There are many existing systems and methods that provide traffic information for media outlets, on-board vehicular telematics, and other third party applications to provide consumers with real-time traffic data for purposes such as routing. However, such systems are reactive in that they generate information representative of an estimate of the current and past traffic state, but not the future or predicted traffic state, and attempt to provide routing for users of roadway segments only once traffic events such as congestion have already occurred.

Existing systems and methods are limited in several ways. There is no robust model that integrates traffic conditions, weather conditions, operational conditions, pavement conditions, and incident or other such events, to model traffic states and generate routing information using all of these types of data. Also, as noted above, existing techniques are reactive—they do not suggest routing from predictive data based on attributes such as weather predictions, traffic predictions, pavement condition states, and patterns of incident data. Finally, existing techniques do not account for, and do not model data in light of, different and multiple reasons why congestion occurs. In short, there is no reliable current method for routing based on predictive models that integrate data from multiple sources, all of which have some impact on traffic conditions on a particular segment of roadway, and attempt to quantify incoming data for improving the resulting output data set.

Quantification of incoming data can have a significant impact on predictive modeling and estimation of traffic states, since traffic, weather, incident, operations, and pavement condition data all have an impact on traffic flow and congestion. Modeling of multiple congestion factors is a known technique, but such modeling, performed alone without integration of different types of data as contemplated in the present invention, is insufficient to provide accurate estimation of traffic states for consumer and commercial uses.

### BRIEF SUMMARY OF THE INVENTION

It is therefore one objective of the present invention to provide a framework for estimating traffic states in a system and method that integrates multiple types of input data affecting traffic congestion. It is another objective of the present invention to provide a framework for generating traffic routing information in response to multiple categories of input data representative of traffic conditions on a particular section of roadway. It is yet another objective of the present invention to generate routing information from predictive modeling of traffic states, for distribution to one or more of consumer uses, in-vehicle telematics, and media outlets.

The present invention provides, in one embodiment of the present invention, enhancements in routing of traffic as an output of traffic state estimation modeling. At the core of traffic state estimation is logic capable of integrating data using a Kalman filter or other data assimilation algorithms into a cell transmission model of the true state of traffic, and further capable of using this cell transmission model to predict future traffic states. Input data for the cell transmission model is, in one embodiment, traffic data collected from sources such as GPS probes and inductive-loop traffic detectors, and may be incorporated into the present invention using a database-driven integrated performance measurement system. Regardless, additional data is also ingested to the core of the traffic state estimation system to improve the quality of output data and enhance the accuracy of routing information generated.

Additional input data ingested in the present invention also includes incident data, observed and predicted weather data, pavement conditions data and predictions of pavement condition states, and roadway operations data. One or more of this additional input data is further modeled using multiple factors of congestion in a regression analysis. The weather data includes data collected from multiple sources that generate observed and predicted weather conditions, and may further include weather information based on data collected from treatment vehicle operations. Pavement condition information includes data provided as an output from systems that model states of roadway surfaces and the various materials comprising the underlying substrates that together form a pavement. Roadway operation data may include operational information about lane closures, events, roadway maintenance, etc. Together, the traffic, incident, operations, pavement, and weather data applied to the traffic state estimation framework provide significant improvements in predictive modeling of traffic states and also increased utility for both public and private entities in providing traffic routing information for consumers and commercial use.

Congestion level on a roadway is often difficult to dissect into various factors, primarily because a number of different variables are frequently involved, making it difficult to provide routing workarounds. The present invention applies a regression approach that models multiple factors of congestion in a method of explaining the congestion level. Such an approach that models these multiple factors serves to modulate at least some of the input data to produce a tighter integration of traffic, weather, incident, operations, and pavement data.

Output data in the form of traffic routing information may be provided to end users in a variety of ways in the present invention. Media, consumers, on-board or in-vehicle telematics are all contemplated as possible users of output data from the traffic state estimation system and method. Such output data may be presented to these users in multiple ways, such as in an interface that includes three-dimensional visualizations and animations, and objects on the interface capable of being manipulated to produce customized information.

Other embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a general block diagram of a system and method of determining routing as a function of traffic state estimation, and data flow within such a system and method, according to one embodiment of the present invention.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it is practiced. Other embodiments will be utilized to practice the present invention and structural and functional changes will be made thereto without departing from the scope of the present invention.

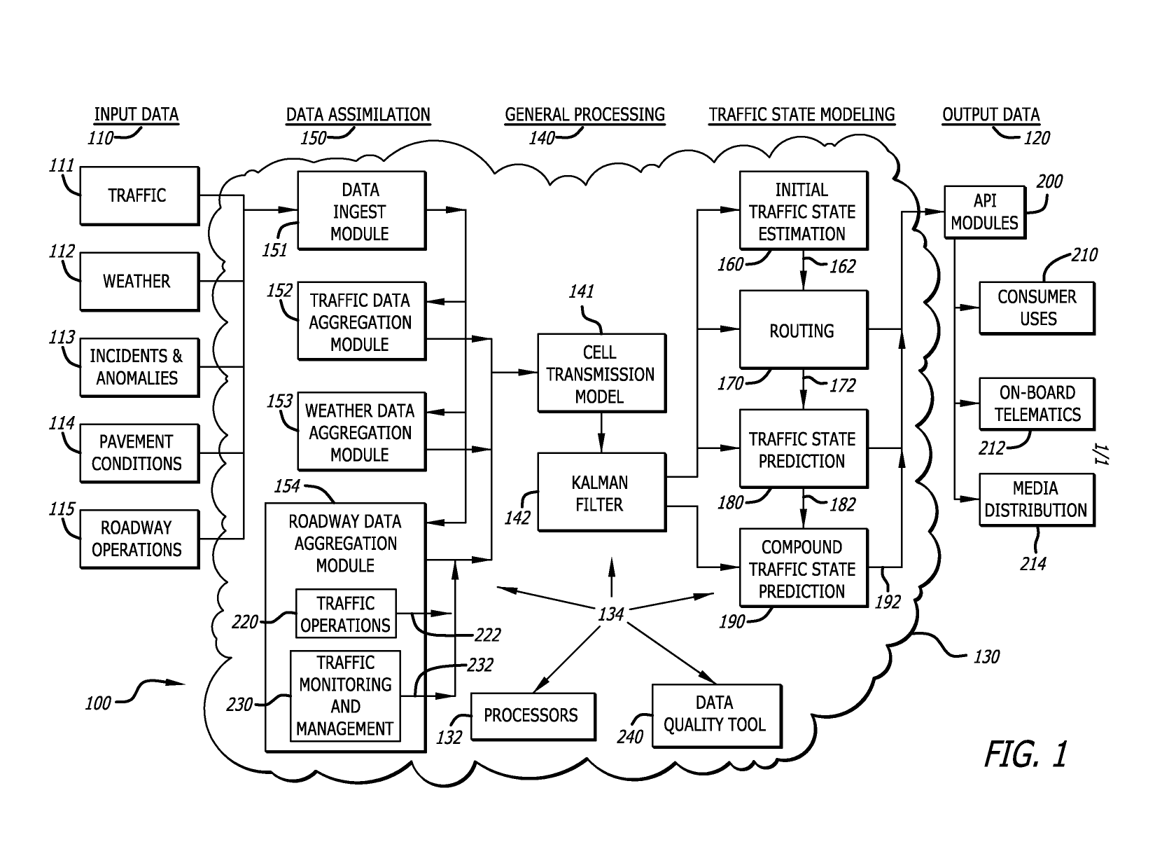

The present invention provides systems and methods of estimating traffic states and generating output data such as routing of traffic in response to multiple categories of input data representative of traffic conditions on a particular section of roadway. FIG. 1 is a block diagram of an integrated traffic state estimation framework 100 incorporating these systems and methods, showing various components involved in determining routing as a function of integrated traffic state estimation. The integrated traffic state estimation framework 100 ingests multiple categories of input data 110 that have an impact on traffic flow, including general traffic data 111 collected from one or more sensors or third parties, weather data 112, incident and anomalies data 113, pavement condition data 114, and roadway operations data 115. Within each category of input data 110, different types of information are provided—for example, incident data 113 may include accidents and police activity, while roadway operations data 115 may include lane closures, road construction works, impact of weather conditions, and many other factors which affect traffic flow. Each of these categories of input data 110 includes data relevant to traffic congestion. Since the integrated traffic state estimation framework 100 of the present invention provides routing information 122 as a component of output data 120, modeling this input data 110 with a thorough understanding of the reasons for congestion within the paradigms discussed herein plays an important role in generating accurate routing information 122.

The present invention operates within a computing environment 130 that includes one or more processors 132 among a plurality of software and hardware components that form at least a part of the integrated traffic state estimation framework 100. The one or more processors 132 are configured to execute program instructions in one or more data ingest and processing modules 134 to perform the approaches and algorithms described herein. These one or more data processing modules 134 include data assimilation components 150, processing components 140 such as a cell transmission model 141 and a filter 141, and multiple components of traffic state modeling to produce estimates of real-time and predictive traffic states and generate reliable, real-time traffic routing information 122 as output data 120. This output data 120 may be applied in one or more application programming interfaces (APIs) within API modules 200 to produce content for the media, on-board vehicle telematics, consumer sectors, and which can be used by mobile devices and applications installed thereon.

A cell transmission model 141 in the present invention integrates the various types of input data 110 with information defining one or more road links of a segmented section of a roadway to be analyzed. Data for processing in a cell transmission model 141 may be organized on a cell-by-cell basis or by groupings of cells, depending on the type and length of roadway being modeled. The cell transmission model 141 is therefore an input data paradigm of traffic measurements, correlated with specific roadway links of a segmented roadway.

One premise of the present invention is that traffic capacity is reduced as events such as adverse weather, incidents, lane closures, events, changes in pavement conditions, and maintenance operations occur. One way to model the impact of such characteristics is as a plot of flow versus density (in what is known as a “fundamental diagram”), where the impact of each of, for example, weather, incidents, and operations can be compared with normal traffic patterns. Application of the many different categories of input data 110 in the present invention to a filter 142 as described herein produces modeled estimates of traffic capacity versus density, which form part of the cell transmission model 141 used to generated streams of output data 120 customized for the particular consumer or media need.

The cell transmission model-based approach of the present invention therefore integrates multiple categories of input data 110 relevant to traffic capacity on a cell-by-cell basis. This data may be historical, real-time, or predictive; regardless, it is applied to the cell transmission model 141, which employs a “snap-to” approach to apply the input data 110 from the multiple sources to defined roadway segments, or road links. The resulting data, integrated and correlated with specific road links, is then applied to a filter 142, which assimilates data related to different roadway segments and applies weights to that data to account for “noise” observations and produce an initial estimate of a traffic state. The output of the filtering process is a representation of the state of traffic on the roadway in the form prescribed by the cell transmission model 141, and is then applied to one or more predictive algorithms to create an ensemble of new network states, representing a probability distribution of the predicted future road network state, that is used to generate further output data 120 for use by media and consumers and noted above.

Filtering according to one embodiment of the present is performed by a Kalman filter 142, which is a known technique for filtering noise from observed information. A Kalman filter 142 uses a series of measurements observed over time, containing noise and other inaccuracies, and produces estimates of unknown variables that tend to be more precise than those based on a single measurement alone. In the present invention, the Kalman filter 142 operates recursively on streams of noisy input data 110 from multiple sources—traffic, weather, incident, pavement, operations, etc.—to produce a statistically optimal estimate of the traffic state.

FIG. 1 shows one embodiment of the integrated traffic state estimation framework 100 in which input data 110, applied to the cell transmission model 141 and Kalman filter 142 described herein, is processed to generate output data 120. In FIG. 1, output data 120 such as traffic routing information 122 (defined over time as R(t)) is generated by applying mathematical operations within one or more data processing modules 134 (such as the routing module 170) to model one or more of the traffic data 111, weather data 112, incident data 113, pavement conditions data 114, and roadway operations data 115 comprising the input data 110.

The one or more data processing modules 134 are shown generally in FIG. 1 as a cell transmission model 141, a Kalman filter 142, a data ingest module 151, a traffic data aggregation module 152, a weather data aggregation module 153, a roadway operations data aggregation module 154, an initial traffic state estimation module 160, a routing module 170, a traffic state prediction module 180, a compound state traffic prediction module 190, and one or more API modules 200. The data ingest module 151 is configured to receive input data 110 from many different sources and distribute to the various aggregation modules 152, 153, and 154. The one or more API modules 200 configure at least the APIs 210, 212, and 214 following generation of the output data 120 from the initial traffic state estimation module 160, the routing module 170, the traffic prediction module 180, and the compound traffic prediction module 190 for consumptive utility, also as further described herein.

Input data 110 that is ingested into the integrated traffic state estimation framework 100 of the present invention includes traffic data 111 from various sources (for processing generally within the traffic data aggregation module 152), real-time and predicted weather data 112 from various sources (for processing generally within the weather data aggregation module 153), and roadway operations data 115 from various sources (for processing generally within the roadway operations data aggregation module 154). As noted above, input data 110 may also include incidents and anomalies 113 that may be either reflected in traffic, weather, and road operations provided by the sources described herein, or generated as a specific set of stand-alone input data. Therefore, incidents and anomalies 113 may be processed within any of the traffic data aggregation module 152, weather data aggregation module 153, and roadway operations data aggregation module 154, or ingested directly, for integration and further processing in the traffic state estimation module 160. Input data 110 may further include pavement conditions 114, which may be ingested directly for processing within the traffic state estimation module 160 by the data ingest module 151. Such pavement condition data may be ingested from output data streams generated separately by a road condition model, such as that described in co-pending U.S. non-provisional patent application Ser. No. 14/148,913, the contents of which are incorporated by reference in full and in their entirety herewith.

Input data 110 may be ingested, as noted above, from a plurality of different sources. For example, in the case of roadway operations data 115, information may be collected by on-board devices such as AVL/MDCs commonly utilized in road maintenance vehicles, which are well known in the art. Such information may also be provided by centralized maintenance decision components configured to help local and regional authorities make managerial decisions about road networks, for example in severe weather. Input data 110 generally may also be ingested from sensors, cameras, third party data collection services, probes, loops, radar, and many other sources, and therefore may be ingested in many different formats.

In another example, weather data 112 may include data from numerical weather prediction models, surface networks, and both in-situ and remotely-sensed observation platforms, and may be ingested into the present invention in a variety of formats. For example, output data from numerical weather models and/or surface networks may be combined with data from weather radars and satellites to reconstruct current weather conditions on any particular link or segment of roadway. There are numerous industry NWP models available, and any such models may be used to input weather information in the present invention. Such NWP models may include RUC (Rapid Update Cycle), WRF (Weather Research and Forecasting Model), GFS (Global Forecast System), and GEM (Global Environmental Model). This weather data is received in real-time, and may come from several different NWP sources, such as from Meteorological Services of Canada's (MSC) Canadian Meteorological Centre (CMC), as well as the National Oceanic and Atmospheric Administration's (NOAA) Environmental Modeling Center (EMC), and many others. Additionally, internally or privately-generated “mesoscale” NWP models developed from data collected from real-time feeds to global observation resources may also be utilized. Such mesoscale numerical weather prediction models may be specialized in forecasting weather with more local detail than the models operated at government centers, and therefore contain smaller-scale data collections than other NWP models used. It is to be understood therefore that the present invention may be configured to ingest data from a plurality of sources, regardless of whether publicly, privately, or internally provided or developed.

In yet another example, traffic data 111 may include speed data and volume data, as well as data indicative of incidents and anomalies, that is reflective of real-time and/or actual conditions being experienced on a roadway. Crowd-sourced observational data may also be provided (whether they be in the form of traffic, weather, incidents, or operations data) from individuals using mobile telephony devices or tablet computers that utilize software tools such as mobile applications, from social media feeds, or any other source or device permitting user entry of relevant information. This traffic-related data may be realized from many different sources as noted further herein. Depending on the source, data may be provided in either a raw form or a processed form. Processed data may be subject to a variety of paradigms that take data generated by sensors or partners and extract relevant information for subsequent use in developing real-time and predicted traffic states estimates in the present invention.

One example of a source of third-party traffic data is from external partners that collect probe data generated by global positioning system (GPS) devices. As noted above, this GPS probe data may be either in a raw form or in a processed form. Raw probe data is a collection of bulk data points in a GPS dataset, while probe data that has been processed has already been associated with information such as traffic speed on a roadway network. This GPS probe data may be pre-processed to develop speed estimates across traffic networks representing large geographic areas. Each such network is comprised of inter-connected links, but it is often the case that obtaining complete link speed estimates is hindered by the sparseness of the input data—i.e., GPS data is typically available for only part of the links representing a larger transportation network, and only for part of the time. In other words, collected GPS data is incomplete, making it hard for these existing systems to accurately estimate traffic speed across inter-connected network segments. Additionally, the quality and comprehensiveness of GPS probe data varies by vendor. One or more processing techniques may be therefore be used in the present invention, either prior to ingest to or within the traffic data aggregation module 144, to iteratively smooth out this data so that any missing values are temporally and spatially filled in to ensure accuracy in the traffic information derived therefrom.

Accordingly, it is to be understood that it is one function of the traffic data aggregation module 152, weather data aggregation module 153, and roadway operations data aggregation module 154 to assimilate all of this input data from the various sources and in various formats, for further processing by other modules 134 in the integrated traffic state estimation framework 100.

Compound traffic prediction 192, defined by the equation T(t+1)=f(T(t),W(t)), provides one methodology for determining traffic states to assist with traffic routing 172 and other permutations of output data 120 according to the present invention. In this equation, T(t) represents the traffic state at time (t), and W(t) represents additional information such as weather and incidents. Data may be ingested for a compound traffic prediction module 190 from a plurality of different sources, including one or more of the traffic data aggregation module 152, the weather data aggregation module 153, the roadway operations data aggregation module 154, the Kalman filter 141, and the initial traffic state estimation module 160. Additionally it is to be understood that data ingested may be in the form of an initial estimation of a traffic state, or may be in the form of historical data maintained in one or more database structures accessible by the one or more processors 132. Compound traffic prediction 192 may be represented in a number of formats, and may be provided to an application programming interface module 200 for development of APIs for consumer uses 210, telematics functionality 212, for script generation for further distribution to media outlets 214, or may be provided directly to the routing module 170 for further processing to prepare routing information 122 such as recommendations for further use by additional consumer applications.

As noted above, routing 172 is performed with output from the compound traffic prediction module 190 as well as output from at least the traffic data aggregation module 152 and the weather data aggregation module 153. Incidents and anomalies 113, pavement condition data 114, and roadway operations data 115 may also be applied to the routing module 170 for routing 172 functions. These types of data are modeled to generate output data 120 that is used to provide consumers with accurate, real-time traffic routing information 122 that integrates traffic, weather, and congestion data.

The traffic data aggregation module 152 is, in one embodiment, an integrated traffic performance measurement system that provides a traffic management tool for aggregating traffic data and computing performance measures for a roadway infrastructure. The integrated traffic performance measurement system provides an extensive set of reporting functions to enable customized visualizations and animations for transportation engineers and others responsible for maintaining and operating roadways. Data is collected for this integrated traffic performance measurement system in a variety of ways. These include sensors placed in or near particular roadways and data gathering techniques such as radar systems and cameras. Third party data may also be incorporated. Such data is processed and analyzed to create multiple measurements for use in traffic management. The integrated traffic performance measurement system also maintains one or more database collections of historical data which is further used in generating for the extensive set of reporting functions.

In the present invention, at least one historical database provides input data from the traffic data aggregation module 152 for the initial traffic state estimation module 160, and for traffic prediction methodologies in further data processing modules 134 that include the traffic-only prediction module 180 and the compound traffic state prediction module 190, which also incorporates weather data. The at least one historical database maintains data from sensors, radar and video, third parties, and may also include historical incident data. Data is also provided from the at least one historical database for visualizations, which is a rendering of output data for traffic monitoring and management in the roadway operations data aggregation module 154.

The initial traffic state estimation module 160 therefore accepts data from the historical database as well as real-time data directly from the sensors, and third party data. This initial traffic state estimation module 160 prepares an initial analysis of a traffic state based on this traffic data performed by a specific data processing module that generates outputs for further processing by the traffic prediction module 180 and the compound traffic prediction module 190.

The weather data aggregation module 154 is an integrated system in which a weather state estimation is determined, at least initially, from data collected from a plurality of weather sensors or ingested from one or more other external sources of weather information as noted above. Weather state estimation is a basis for prediction of weather, which is then “snapped” to coordinates of a road network to be modeled. Accordingly, the weather data aggregation module 154 may be configured to perform one or more of weather prediction and road link conditions prediction.

The combination of weather prediction data snapped to the road network may be supplied directly within the present invention to perform compound traffic prediction 192, or may be provided as input data for road link conditions prediction within the weather data aggregation module 154. Road link conditions prediction is a modeling of weather data 112 with roadway link data to predict specific roadway conditions on a link by link basis in light of predicted weather conditions in the area of the roadway links. This information may be further combined with data that is ingested either directly from treatment vehicles, such as snow plows and deicers, or modulated by management directives issued by winter maintenance decision systems responsive to conditions and materials data reported by treatment vehicles. As noted herein, data from the treatment vehicles and/or management directives may be also supplied directly to the road operations data aggregation module 154 to assist in conducting traffic operations 222 and for traffic monitoring and management 232. Regardless, the output of the weather data aggregation module 153 includes many types of weather-related data, such as real-time weather information, predictive weather data combined with road link data, predicted road link conditions in view of weather data 112, or data ingested from treatment equipment of reflective of management directives in light of such data and provided to the routing methodology through traffic operations of the roadway operations data aggregation module 154.

The roadway operations data aggregation module 154 is an integrated system that provides data related to traffic incidents, lane closures, road maintenance or construction, events, weather, and other characteristics of roadway conditions that have an impact on the flow of traffic in a particular area or with regard to a particular section of roadway. The road operations data aggregation module 154 may model traffic operations 222 and traffic monitoring and management activities 232, and generates data to perform specific routing information 122 for tow trucks, snow plows, and other maintenance and management vehicles. The resulting output data provided to the routing module 170 within the integrated traffic state estimation framework 100 of the present invention is at least reflective of operations as a function of time [Ops(t)], which attempts to measure incident and operational information such as where and when did a maintenance or management vehicle conduct operations, and where and for long a particular incident, event, lane closure, or other activity will impact the flow of traffic.

Traffic operations 222, and traffic monitoring and management 232, are activities within the roadway operations data aggregation module 154 that may be conducted, for example, by a state department of transportation that monitors incidents and their impact on roadways within a particular state. States may integrate data generated from the traffic data aggregation module 153 and the weather data aggregation module 154 for traffic monitoring and management, and also generate output data for the routing module 170. This is illustrative of the deep integration and overlapping usage of data within the various aspects of the present invention.

Pavement condition data 114 may also be applied to the cell transmission model 141 of the integrated traffic state estimation framework 100, and as with other types of input data 110, may be assimilated for modeling within one or more of the data aggregation modules 152, 153, and 154 or applied directly as input to the traffic state estimation module 160, routing module 170, traffic prediction module 180, or compound traffic prediction module 190. In the weather data aggregation module 153, for example, pavement condition data 114 may be modeled as a function of road link condition prediction, together with predicted weather data 112, and therefore data regarding pavement conditions 114 may therefore be represented as a component of the data output of the weather data aggregation module 153. Similarly, data regarding pavement conditions 114 may be historical and maintained in one or more database locations that are accessible by the one or more processors 132, and may be generated by traffic operations 220 or traffic monitoring and management 230 modules. Regardless of whether pavement condition data 114 is collected, modeled, and/or predicted in conjunction with weather data 112 by the traffic data aggregation module 152, the weather data aggregation module 153, or the roadway operations data aggregation module 154, pavement condition data 114 may be considered relevant to determining routing information for media and consumer applications, since pavement conditions can have a measureable impact on traffic flow.

Pavement condition data 114 may be provided as output data from a modeling paradigm that simulates pavement condition states from behavior of a pavement in response to traffic, weather, and road conditions on a particular section or segment of a transportation infrastructure or roadway network, and provides predictions of pavement condition states over specific periods of time. Such a pavement conditions modeling paradigm predicts pavement condition states by analyzing and modeling both mass and energy fluxes and balances in simulated pavement behavior in response to various types of data, using, for example, an equation of unsteady heat flow, combined with sophisticated parameterizations for representing heat and moisture exchanges between the road, the atmosphere, and the pavement composition, such as one or more substrates.

One methodology for capitalizing on distinctions between mass and energy balance in formulating pavement condition simulations and predictions is by using the fact that the freeze point of water can be reduced by adding certain chemicals to a treatment mixture to be applied to a pavement, such as for example salt. The pavement condition modeling paradigm generating pavement condition data 114 in the present invention may, in one aspect, partition the moisture atop a pavement surface into sections representing different possible forms that moisture can take (e.g., liquid, snow, ice, frost, compacted snow, etc.), and then uses the eutectic properties of any chemicals that are added to the mix to repartition the moisture between these sections. In this repartitioning process, mass and energy balance are maintained, since when salt is applied to a pavement with frozen moisture on it, the composition and pavement surface temperature will typically undergo a rapid drop, followed by a slower recovery. As time passes, energy will normally be drawn upward from lower in the roadbed either in or beneath the pavement substrate, permitting the road to warm back up to near its original temperature again. This permits simulation of the simultaneous impacts of multiple deicers, each with differing properties. The importance of this ability to appropriately manage the partitioning of moisture into its different forms is that it directly influences how traffic will impact the pavement's condition, and therefore, pavement condition data 114 may provide an important additional indicator of reasons for traffic congestion modeling according to the present invention.

Each of the traffic data 111, real-time/observed and predicted weather data 112, incidents and anomalies data 113, pavement condition data 114, and roadway operations data 115 affects, in some manner, roadway traffic congestion. Because of this, it is essential to providing improved and enhanced routing information to apply methods that enable further understanding of the reasons why traffic congestion occurs. The present invention therefore contemplates applying existing methods of modeling traffic congestion to modulate the input data to produce a tighter integration of traffic, weather, incident, pavement, and roadway operations data.

One such method of understanding and modeling traffic congestion is a regression approach that divides the total congestion delay in a roadway section into multiple components. These include the delay caused by incidents, special events, lane closures, and adverse weather; the potential reduction in delay at bottlenecks that ideal ramp metering can achieve; and the remaining delay, due primarily to excess demand. Modeling using these multiple components involves two steps. First, the components of non-recurrent congestion are estimated by statistical regression. Second, all traffic bottlenecks are identified, and the potential reduction in delay that ideal ramp metering to control entry into roadways can achieve is estimated. This method can be applied to any road link with minimum calibration, as it requires data about traffic volume and speed, the time and location of incidents, special events and lane closures, and adverse weather.

In this regression approach, total congestion is represented by Dₜₒₜₐₗ. The method of modeling traffic congestion divides the total congestion Dₜₒₜₐₗ into six components: (1) D_{col}, the congestion caused by incidents, which could be reduced by quicker response; (2) Dₑᵥₑₙₜ, the congestion caused by special events, which could be reduced by public information and coordination with transit; (3) Dₗₐₙₑ, the congestion caused by lane closures, which could be reduced by better scheduling of lane closures; (4) D_{weather}, the congestion caused by adverse weather, which could be reduced by demand management and a better weather response system; (5) Dₚₒₜ, the congestion that can be eliminated by ideal ramp metering; and (6) the residual delay, D_{excess}, largely caused by demand that exceeds the maximum sustainable flow of traffic.

This approach is applied to a contiguous section of roadway with n detectors indexed i=1, . . . , n, whose flow and speed measurements are averaged over specific time intervals t. Detector i is located at post-mile xᵢ; speed is measured in miles per hour (mph) as vᵢ(d,t)=v(xᵢ, d, t) and qᵢ(d,t)=q(xᵢ, d, t) is the flow (vehicles per hour, vph) at time t of day d.

The n detectors divide the roadway into segments. Each segment's congestion delay may be defined as the additional vehicle-hours traveled driving below free flow speed v_{ref}, taken to be an assumed value, such as for example 60 mph. The total delay in the freeway section on day d is the delay over all segments and times.

The approach divides the average daily total delay into six components as in the following equation:

Dₜₒₜₐₗ=D_{col}+Dₑᵥₑₙₜ+Dₗₐₙₑ+D_{weather}+Dₚₒₜ+D_{excess}

Total congestion is also divided by recurrent and non-recurrent delay, where D_{rec} is the daily ‘recurrent’ delay, and D_{non-rec} is the daily ‘non-recurrent’ delay. Applying the recurrent and non-recurrent congestion to the total delay,

D_{non-rec}=D_{col}+Dₑᵥₑₙₜ+Dₗₐₙₑ+D_{weather} and

D_{rec}=Dₜₒₜₐₗ−D_{non-rec}=Dₚₒₜ+D_{excess}

Dₜₒₜₐₗ, calculated from flow and speed data, is the average daily total delay. D_{col}, Dₑᵥₑₙₜ, Dₗₐₙₑ and D_{weather} are components of ‘non-recurrent’ congestion. The difference between their sum and Dₜₒₜₐₗ is the ‘recurrent’ congestion. A portion of recurrent congestion due to frequently occurring bottlenecks could be reduced by ramp metering. That potential reduction is estimated as Dₚₒₜ. The remaining delay, D_{excess}, is due to all other causes, most of which is likely due to demand in excess of the maximum sustainable traffic flow. The delay due to excess demand can only be reduced by changing trip patterns.

The components of non-recurrent delay are identified using the following model,

Dₜₒₜₐₗ(d)=β₀+β_{col}X_{col}(d)+βₑᵥₑₙₜXₑᵥₑₙₜ(d)+βₗₐₙₑXₗₐₙₑ(d)+β_{weather}X_{weather}(d)+ε(d),

where
ε(d) is the error term with mean zero,
X_{col}(d) is the number of incidents on day d,
Xₑᵥₑₙₜ(d) is the number of congestion-inducing special events such as sporting events on day d,
Xₗₐₙₑ (d) is the number of lane-closures on day d, and
X_{weather} (d) is the 0-1 indicator of adverse weather condition on day d.

The explanatory variables above may be augmented if additional data are available. For example, Xₑᵥₑₙₜ(d) may be the attendance at special events instead of the number of special events; Xₗₐₙₑ (d) may be the duration instead of the number of lane closures; and X_{weather} (d) may reflect precipitation.

The regression analysis for congestion modeling assumes that each incident, special event, lane-closure, and adverse weather condition contributes linearly to the delay. If enough data is available, and the interaction is strong enough, interaction terms indicative of complicated causality between explanatory variables, such as between the bad weather and the number of accidents, may be considered.

Fitting the regression analysis to the data via linear least squares gives the parameter estimates, denoted β₀, β_{col}, βₑᵥₑₙₜ, βₗₐₙₑ and β_{weather}. The components of the total delay are:

D_{col}=β_{col}×avg{X_{col}(d)}

Dₑᵥₑₙₜ=βₑᵥₑₙₜ×avg{Xₑᵥₑₙₜ(d)}

Dₗₐₙₑ=βₗₐₙₑ×avg{Xₗₐₙₑ(d)}, and

D_{weather}=β_{weather}×avg{X_{weather}(d)},

in which the average is taken over days, d=1, . . . , N.

The intercept β₀ is the delay when there are no incidents, special events, lane-closures, or adverse weather. Thus, it may be identified with recurrent congestion, since it equals total delay minus the non-recurrent delay _{Dnon-rec} defined above,

β₀=D_{rec}=Dₜₒₜₐₗ−D_{non-rec}

The next step is to divide the recurrent delay into the delay that can be eliminated by ramp metering and the delay due to excess demand. For this, the present invention identifies recurrent bottlenecks on the roadway section using an automatic bottleneck identification algorithm. Then, ideal ramp metering, or IRM, is performed on those recurrent bottlenecks that are activated on more than 20% of the weekdays considered.

For a specific recurrent bottleneck, let segments i and j be the upstream and downstream boundaries of the bottleneck, respectively. For the upstream boundary j, use the median queue length of the bottleneck. Then the total peak period volume at the two locations is calculated. The difference between the two is the difference between the total number of vehicles incoming or exiting the roadway between the two segments. The present invention assumes that all those vehicles contributing to the difference are arriving (or leaving) at a virtual on-ramp (off-ramp) at the upstream segment i. Also, the time-series profile of that extra traffic is assumed identical to the average of those at segment i and j. That enables computation of the modified total input volume profile at the segment i. The capacity of the whole section is the maximum sustainable (over 15-minute) throughput at location j, and this is computed from empirical data. The virtual input volume at segment i is metered at 90% of Cⱼ, to prevent the breakdown of the system, assuming (1) that the metered traffic will be free flow at or above the assumed speed throughout the roadway section, and (2) that the upstream meter has infinite capacity. Thus, under IRM, the delay occurs only at the meters. The potential savings from IRM at these bottlenecks for each day d is then computed as,

Dₚₒₜ(d)=DBN, before IRM(d)−DBN, after IRM(d)

Here DBN, before IRM(d) and DBN, after IRM(d) is the delay at the bottlenecks before and after IRM is run. The average daily potential saving is

Dₚₒₜ=min{median(Dₚₒₜ(d),d=1, . . . ),D_{rec}}

The median instead of the mean is used to ensure that the influence of incidents and special events etc. is minimized in the computation. Also, the potential saving cannot be larger than the total recurrent delay D_{rec}.

The present invention may further include a hybrid machine learning tool configured to introduce a realistic randomness to the predictions of traffic states derived from the cell transmission model and filtering approach of the traffic state estimation framework 100. Random events that may not be represented by the input data contemplated by the present invention can be included in modeling within the traffic state estimation framework 100 by performing continuing simulations on possible outcomes. Outputs from these simulations may be incorporated in the cell transmission model 141 and Kalman filter 142 to add robust predictive traffic data that models random events having an impact on traffic flow.

The present invention may also include one or more modules in a data quality tool 240 configured to identify and impute missing information among the input data needed to provide accurate routing information for the end user. In such a data quality tool 240, actual data that is identified as not present or of insufficient quality may be replaced by synthetic data. Such synthetic data may be taken from a model-based imputation or from historical data identified as most similar to the data that is identified as missing or of insufficient quality.

As noted above, one utility of the present invention is for routing 172 of traffic in view of the input data 110 and the various mathematical modeling functions performed in the traffic state estimation framework 100. Routing 172 itself involves a further application of various approaches and algorithms to the output of the cell transmission model 141, Kalman filter 142, and predictive traffic modules, for determining routing of traffic as an output 120 of a traffic state estimation framework 100. Depending on the type, quantity, and quality of input data 110 ingested into one or more modules comprising data processing components of a traffic state estimation framework 100 according to the present invention, one or more of the ways of determining routing discussed herein may be used.

One approach to routing 172 involves determining the standard shortest path routing, using static link weights based on speed limits and lengths. Routing 172 may also be based heavily on traffic information such as the historical traffic conditions for the time of day at the start of a trip over a specific distance. Historical time-of-day link weights may also be used for routing 172 based on historical averages, in which the link weights are dynamic. Routing 172 based on traffic information may also be able to predict the future traffic conditions based on current conditions and historical trends.

Routing 172 may also be based heavily on weather information. In one approach, routing 172 using any of the standard predictive traffic algorithms discussed above are used, and then weather information is incorporated to advise roadway users about the weather on a trip, using either the current weather or the predicted conditions. This approach assumes a level of sufficient granularity at the appropriate temporal and spatial scales to generate accurate results. It should be noted that this approach does not integrate weather data for determining routing. Instead, it provides weather information for a desired trip route based on a desired departure time.

Additional services about routes may also be provided in conjunction with the weather. A full travel-time profile may be provided for the hours around a desired departure time that advises which trips would have weather events occurring thereon. Using this approach, roadway users may be advised, for example, to leave two hours early or two hours late to avoid potentially adverse weather conditions. Alerts may also be provided based on weather events for a trip that a motorist has entered into, for example, an application on a mobile computing device.

Routing 172 may also fold in current weather data, similar to routing using historical traffic conditions, with static link weights. An approach to routing 172 that utilizes current weather data includes modification of link weights based on weather—for example, if rain is falling, then there is an expected 20% drop in speed, etc. Routing may also be based on being able to predict the weather during the course of a trip. Link weights in such an approach are dynamic and based on both predicted traffic and/or predicted weather.

Routing 172 may also be based heavily on roadway operations. In one approach, routing 172 using any of the traffic or weather algorithms in the preceding paragraph are used, but roadway data is integrated to provide users with information about which roads have been recommended to have treatment vehicles such as snow plows on them, and at which times. This approach tracks what operations roadway treatment vehicles are presently conducting to perform routing. For example, if a road has been recently cleared, then routes using the cleared streets would be given lower weights in the routing algorithm so that users could be routed onto the recently-cleared streets in a “safety routing” model.

Routing 172, according to another embodiment of the present invention, may also incorporate all of the above data in a “kitchen sink” approach that provides the ability to modulate link weights based on predicted traffic, predicted weather, and predicted treatment vehicle operations, as well as incident data, pavement conditions and congestion modeling. Such an approach utilizes roadway speed information gathered using, for example, an integrated performance measurement system and interface, information regarding weather prediction and collected from maintenance support systems, and data collected from treatment vehicles such snow plows, folded back into the maintenance support systems to update roadway modeling. Routing 172 from such an approach may be useful in a number of ways. For example, this “kitchen sink” routing may be output to a “511” information system currently in wide use for an improved “safety-ready” output using the above routing algorithms that greatly improves public safety on roadways. In such an example, users could be told when to initiate trips to and from work based on when snow plows are scheduled to clear those routes—improving public safety by helping commuters decide whether to wait for the snow plows or not.

As discussed herein, output data 120 in the present invention may, in one embodiment, take the form of routing information 122 that reflects the current and predicted traffic state for a specific area or section of a road network. This routing information 122 may be presented in many forms. For example, public and private entities desire to provide consumers, whether they be public-level announcement systems, service providers, traffic engineers and maintenance personnel, or private entities such as corporations or individuals, with information necessary to move about roadways in an efficient manner. One example of a private entity is media networks and outlets wishing to provide traffic information, often in visual or animated form, for their viewers or readers. Regardless of the form or type of entity receiving output data 120, it may be presented in a number of different ways to meet customer needs. These include in-vehicle telematics, a public or closed-system dashboard interface on web site, or for transmission over media communications networks.

The output data 120, as noted above, may also be presented in one or more visualizations or animations to aid in the interpretation of or downstream presentation of traffic state output data 120 using a graphical user interface. Visualizations and animations may be provided directly to consumers, such as media outlets, for use in their own presentation systems, or may be provided via a dedicated interface. Data in visualizations may be presented, for example, in the form of tool bars, widgets, charts, graphs, and pull-down menu options. Additionally, visualizations may be presented as three-dimensional animated objects representing moving vehicles on a virtual roadway. Regardless, it is to be understood that the present invention includes additional modules configured to generate such visualizations and animations of output data, which may be customized according to specific preferences of the end user of such information.

The systems and methods of the present invention may be implemented in many different computing environments 130. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of the present invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA.RTM or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A method comprising:
ingesting input data comprising traffic data, observed and predicted weather data, incident data, pavement condition data, and roadway operations data;
modeling the input data to generate one or more estimations of a traffic state, the modeling at least comprising:
applying the traffic data, the observed and predicted weather data, the incident data, the pavement condition data, and the roadway operations data to a cell transmission model configured to integrate the input data with road link data representative of a segmented roadway network,
modulating at least one of the traffic data, the observed and predicted weather data, the incident data, the pavement condition data, and the roadway operations data in a regression analysis to separate recurring and non-recurring traffic conditions causing delay to identify and explain at least one reason for the delay at specific road links of the segmented roadway network, and
filtering the integrated and modulated input data by applying weighting coefficients to account for noise in the input data and generate an ensemble of new roadway network traffic states representing a probability distribution of predicted future traffic states for the specific road links in the segmented roadway network; and
generating output data representative of routing information relative to one or more road links of the segmented roadway network.

2. The method of claim 1, further comprising receiving the traffic data from a plurality of sources that include one or more of traffic sensors, probes and detectors, camera and video systems, global positioning systems, historical database collections, and in-vehicle communication equipment.

3. The method of claim 1, further comprising receiving the weather data from a plurality of sources that include one or more of radar systems, surface networks, image-based systems, and numerical weather prediction models, wherein the weather data is representative of real-time observed and predicted weather states.

4. The method of claim 1, further comprising receiving the pavement condition data from a road condition model configured to generate output data representative of simulations of pavement condition states from behavior of a pavement response to one or more of weather conditions, traffic flow characteristics, and experienced roadway conditions.

5. The method of claim 1, wherein at least one of the traffic data, weather data, incident data, pavement condition data, and the roadway operations data is collected from one or more crowd-sourced observations generated by users of the specific road links on the segmented roadway network.

6. The method of claim 1, further comprising assimilating the input data in one or more of a traffic data aggregation module, a weather data aggregation module, and a roadway data aggregation module prior to application to the cell transmission model for integration with the road link data representative of a segmented roadway network.

7. The method of claim 1, further comprising applying the output data to at least one application programming interface to generate a routing recommendation.

8. The method of claim 1, further comprising applying the output data to at least one application programming interface configured to provide information for one or more of media end users, consumer end users, and on-vehicle telematics.

9. The method of claim 1, wherein the generating output data representative of routing information further comprises generating one or more of animations and visualizations for displaying the routing information on a graphical user interface.

10. A traffic state estimation system, comprising:
a computer processor; and
at least one computer-readable storage medium operably coupled to the computer processor and having program instructions stored therein, the computer processor being operable to execute the program instructions to model one or more estimations of a traffic state within a plurality of data processing modules, the plurality of data processing modules including:
a plurality of data assimilation components configured to ingest input data relative to traffic flow, the plurality of data assimilation components at least including a traffic data aggregation module, a weather data aggregation module, and a roadway operations data aggregation module, wherein the input data relative to traffic flow includes traffic data, observed and predicted weather data, incident data, pavement conditions data, and roadway operations data;
a cell transmission model configured to integrate the input data relative to traffic flow with road link data representative of a segmented roadway network;
a module configured to apply a regression analysis to at least one of the traffic data, the observed and predicted weather data, the roadway operations data, pavement condition data and predictions, and the incident data to separate recurrent and non-recurrent traffic conditions causing delay to identify and explain at least one reason for the delay at specific road links of the segmented roadway network; and
a filter configured to apply weighting coefficients to generate an ensemble of new roadway network traffic states in one or more traffic prediction modules, the ensemble of new roadway network traffic states representing a probability distribution of predicted future traffic states for specific road links in the segmented roadway network.

11. The system of claim 10, wherein the plurality of data assimilation components ingests the traffic data from a plurality of sources that include one or more of traffic sensors, probes and detectors, camera and video systems, global positioning systems, historical database collections, and in-vehicle communication equipment.

12. The system of claim 10, wherein the plurality of data assimilation components ingests the weather data from a plurality of sources that include one or more of radar systems, surface networks, image-based systems, and numerical weather prediction models, wherein the weather data is representative of real-time observed and predicted weather states.

13. The system of claim 10, wherein the plurality of data assimilation components ingests the pavement condition data from a road condition model configured to generate output data representative of simulations of pavement condition states from behavior of a pavement response to one or more of weather conditions, traffic flow characteristics, and experienced roadway conditions.

14. The system of claim 10, wherein the plurality of data assimilation components includes an integrated traffic performance measurement system configured to aggregate the traffic data.

15. The system of claim 10, wherein the plurality of data assimilation components includes a roadway operations data aggregation system configured to model roadway infrastructure operations and management activities from at least one of traffic data and roadway operations data.

15. The system of claim 10, wherein the plurality of data assimilation components ingests at least one of the traffic data, weather data, incident data, pavement condition data, and the roadway operations data from one or more crowd-sourced observations generated by users of the specific road links on the segmented roadway network.

16. The system of claim 10, further comprising an application programming interface module configured to generate a routing recommendation.

17. The system of claim 10, further comprising an application programming interface module configured to generate information for one or more of media end users, consumer end users, and on-vehicle telematics.

18. The system of claim 10, further comprising an application programming interface module configured to generate one or more of animations and visualizations for displaying information on a graphical user interface.

19. A method of estimating a traffic state, comprising:
predicting an initial traffic state from a cell transmission model configured with input data representing one or more characteristics of traffic flow and integrated with road links representing a segmented roadway network, the input data including traffic data, observed and predicted weather data, incident data, pavement conditions data, and roadway operations data;
separating recurring and non-recurring traffic conditions causing delay in a regression analysis configured to identify and explain at least one reason for the delay at specific road links representing the segmented roadway network; and
estimating a future traffic state by filtering output data from the regression analysis by applying weighting coefficients to generate an ensemble of new roadway network traffic states representing a probability distribution of predicted future traffic states for the specific road links in the segmented roadway network.

20. The method of claim 19, further comprising receiving the traffic data from a plurality of sources that include one or more of traffic sensors, probes and detectors, camera and video systems, global positioning systems, historical database collections, and in-vehicle communication equipment.

21. The method of claim 19, further comprising receiving the weather data from a plurality of sources that include one or more of radar systems, surface networks, image-based systems, and numerical weather prediction models, wherein the weather data is representative of real-time observed and predicted weather states.

22. The method of claim 19, further comprising receiving the pavement condition data from a road condition model configured to generate output data representative of simulations of pavement condition states from behavior of a pavement response to one or more of weather conditions, traffic flow characteristics, and experienced roadway conditions.

23. The method of claim 19, further comprising determining a routing recommendation for the specific road links representing the segmented roadway network from the ensemble of new roadway network traffic states.

24. The method of claim 23, further comprising generating one or more of animations and visualizations for displaying the routing recommendation on a graphical user interface.

25. The method of claim 19, further comprising output data for one or more of media end users, consumer end users, and on-vehicle telematics.
